(19) United States
(12) Patent Application Publication
(10) Pub. No.: US 2008/0177738 A1
(43) Pub. Date: Jul. 24, 2008

(54) MAP DATA PROCESSING METHOD AND APPARATUS

(75) Inventor: Kenji Ito, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited., Kawasaki (JP)

(21) Appl. No.: 11/968,257

(22) Filed: Jan. 2, 2008

(30) Foreign Application Priority Data
Jan. 22, 2007 (JP) 2007-010961

(51) Int. Cl. G06F 17/30

(52) U.S. Cl. 707/6; 707/E17.001

(57) ABSTRACT

In order to present information about a specific position on a map in a mode users can easily understand, a map data processing method includes: identifying a display range of a map; identifying a content and a map element, which are associated with a position within the display range of the map and whose positions are presumed to be identical by using a contents data storage storing position data for each content and a map element data storage storing position data and attribute data for each map element; comparing the attribute data of the identified content with the attribute data of the identified map element stored in the map element data storage; and determining a display mode for the identified content based on a comparison result, and outputting the map within the display range, wherein the map includes display data according to the determined display mode.

### TECHNICAL FIELD OF THE INVENTION

This invention relates to a processing technique of map data, more particularly to a technique for appropriately displaying contents or icons corresponding to the contents on a map.

### BACKGROUND OF THE INVENTION

A service, which enables to search images and/or blogs relating to a specific position from a map when position information is registered for the images and/or blogs, appears one after another. If the image and/or blog is registered once, it keeps being displayed on the map. However, there is a case where the store introduced in the blog has already moved, because of the vacation or the like. Such a situation can frequently occur in these days when various urban developments is being performed.

For example, in a screen as shown in FIG. 1, a position where a blog is registered is represented by a square icon. And, an icon 1002 is positioned on a road 1001, and when this icon 1002 is clicked, a window to display the pertinent blog is displayed or a portion of the blog such as a title is displayed as a tag. However, an icon 1002 for a Chinese restaurant is positioned on the road 1001. This is because the Chinese restaurant of the icon 1002 had to move because of the expansion of the road 1001 and does not exist now. However, unless a registrant of the blog changes the registered content, it keeps being represented, readers cannot judge whether or not the position indicated by the icon is correct, and there is possibility that they swallow such incorrect information.

In addition, in a car navigation system equipped in a car now, a photographed image can be registered in association with a specific position, and as for the type of the image, in addition to a sightseeing snapshot, an image for a marker to record that the map is different from an actual state (e.g. an image to indicate that a bank is shown in the map, but a convenience store is actually located now.) may be registered. However, as shown in FIG. 2, only by showing the thumbnail and/or icon at the image-registered position on the map, it is impossible to distinguish whether it is the snapshot or image for the marker, unless icons 1003 are individually clicked to instruct to display the tags 1004. This causes a problem that the driver overlooks the thumbnail and/or icon.

In addition, JP-A2003-98958 discloses a technique enabling a reader to judge accuracy of electronic map data. Specifically, by an information provision apparatus, an information presentation system is constructed to present the content of an electronic map database to a client PC through the Internet INT. In the map database, element data to store shape or the like of building or the like, and attribute data to store its type or the like, and further judgment index data to judge accuracy of the element data and attribute data are stored. The judgment index data can include, for example, information concerning the time course from the obtainment of the data, information concerning data obtaining method, information concerning presentation precision such as the number of effective digits at the data presentation, or the like. By presenting the judgment index data in addition to the map data, the reader can judge the accuracy of the map data. However, the display mode is not changed based on whether or not the attribute of the content associated with the specific position on the map is identical with the attribute of the map element registered in the map.

In the aforementioned conventional arts, it is impossible to judge whether or not the information about the specific position on the map is correct and easily grasp what content is displayed on the map.

### SUMMARY OF THE INVENTION

Therefore, an object of this invention is to provide a new technique for presenting information about the specific position on the map in a mode users can easily understand.

In addition, another object of this invention is to provide a technique for presenting information representing whether or not the information about the specific position on the map conforms with the actual state, according to the situation in a mode the user can easily understand.

Furthermore, still another object of this invention is to provide a technique for switching display modes of the information about the specific position on the map according to attributes of that information.

A map data processing method according to this invention includes: identifying a display range of a map; identifying a content and a map element, which are associated with a position within the display range of the map and whose positions are presumed to be identical by using a contents data storage storing position data for each content and a map element data storage storing the position data and attribute data for each map element; comparing the attribute data of the identified content with the attribute data of the identified map element stored in the map element data storage; and determining a display mode for the content based on the comparison result and outputting the map within the display range, wherein the map includes display data according to the determined display mode.

When the content is incorrect according to the actual state or the map element registered in the map is incorrect, those attribute data becomes inconsistent. On the other hand, if the content and the map element are correct, those attribute data becomes consistent. Thus, by changing the display mode according to the consistency of the attribute data, it becomes possible to present the map data in a form the user can easily understand.

Incidentally, the aforementioned identifying the content and the map element may include: identifying a content associated with a position within the identified display range of the map; and extracting an map element at a position, which is presumed to be identical with a position of the identified content, from the map element data storage.

In addition, the aforementioned identifying the content and the map element may include: identifying a map element associated with a position within the identified display range of the map; and extracting a content whose position is presumed to be identical with the position of the identified map element, from the content data storage.

Furthermore, the content data storage may store the contents. Then, a format that the content includes the attribute data may be adopted. For example, the image data in an Exif format may be stored in the contents data storage.

In addition, the aforementioned content data storage may store the attribute data for each content. For example, the content may be a blog or simple image data.

Furthermore, the aforementioned attribute data may be data concerning a content type of the content. For example, the attribute data is a type of a store described in the content or a store photographed in the content.

In addition, when the aforementioned comparison result represents inconsistency, the aforementioned display mode of the content may be a display mode to emphasize the inconsistency. For example, in order to urge the user to pay attention to the incorrectness of the content, this display mode is adopted.

Furthermore, for example, in a destination setting mode in a car navigation system, when the comparison result represents inconsistency, the display mode of the content may be a mode that the content is not displayed. In addition, when the comparison result represents consistency, the display mode of the content may be a mode that the content or display data corresponding to the content is displayed. When the car navigation system is in the destination setting mode, the destination can easily be set by presenting the contents whose attribute data is identical rather than “not identical”.

In addition, in a running mode in the car navigation system, when the comparison result represents inconsistency, the display mode of the content may be a mode that the content or display data corresponding to the content is displayed. Then, when the comparison result represents consistency, the display mode of the content may be a mode that the content is not displayed. When the car navigation system is in the running mode, by presenting the content whose attribute data is not identical, it becomes possible to urge the driver to pay attention to the content.

Furthermore, this invention may further include, when a selection instruction of the display data is received, outputting data concerning the content corresponding to the display data and data explaining the inconsistency of the comparison result. This enables to refer to the detailed data.

Incidentally, it is possible to create a program for causing a computer to execute the aforementioned method, a program for causing the conference management server or the presence server to execute the aforementioned processing and a program for causing the portable terminal to carry out the aforementioned operation. The programs are stored into a storage medium or a storage device such as, for example, a flexible disk, a CD-ROM, a magneto-optical disk, a semiconductor memory, or a hard disk. In addition, the programs may be distributed as digital signals over a network in some cases. Data under processing is temporarily stored in the storage device such as a computer memory.

Incidentally, the method may be executed not only in the normal computer but also the car navigation system.

### BRIEF DESCRIPTION OF THE DRAWINGS

FIG. 1 is a diagram to explain a problem in a conventional art;

FIG. 2 is a diagram to explain a problem in a conventional art;

FIG. 3 is a system outline diagram of a first embodiment of this invention;

FIG. 4 is a diagram showing an example of data stored in a contents DB;

FIG. 5 is a diagram showing an example of data stored in the map DB;

FIG. 6 is a diagram showing an example of data stored in a map element DB;

FIG. 7 is a diagram showing a processing flow of a contents registration processing;

FIG. 8 is a diagram showing an example of a contents registration screen;

FIG. 9 is a diagram showing a first portion of a main processing flow in the first embodiment of this invention;

FIG. 10 is a diagram showing an example of data stored in a work memory in the first embodiment of this invention;

FIG. 11 is a diagram showing a second portion of the main processing flow in the first embodiment of this invention;

FIG. 12 is a diagram showing a screen example in the first embodiment of this invention;

FIG. 13 is a diagram showing a processing flow of a tag generation processing;

FIG. 14 is a functional block diagram of a second embodiment of this invention;

FIG. 15 is a diagram showing an example of data stored in an image DB;

FIG. 16 is a diagram showing an example of data stored in the image data;

FIG. 17 is a diagram showing an example of data stored in a map DB;

FIG. 18 is a diagram showing an example of data stored in a map element DB;

FIG. 19 is a diagram showing a first portion of a main processing flow in the second embodiment of this invention;

FIG. 20 is a diagram showing an example of data stored in a work memory in the second embodiment of this invention;

FIG. 21 is a diagram showing a second portion of the main processing flow in the second embodiment of this invention;

FIG. 22 is a diagram showing a screen example in the moving;

FIG. 23 is a diagram showing a first portion of a processing flow of a destination setting processing;

FIG. 24 is a diagram showing a screen example at the destination setting;

FIG. 25 is a diagram showing a second portion of the processing flow of the destination setting processing; and

FIG. 26 is a functional block diagram of a computer.

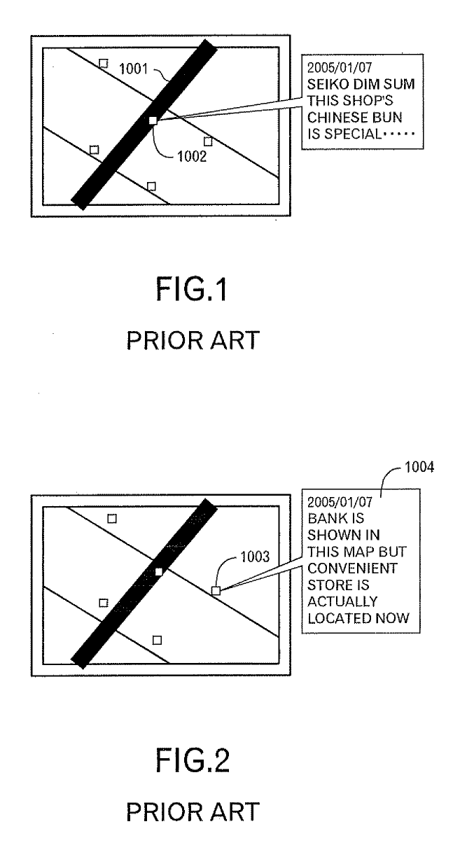

### DETAILED DESCRIPTION OF THE PREFERRED EMBODIMENTS

### Embodiment 1

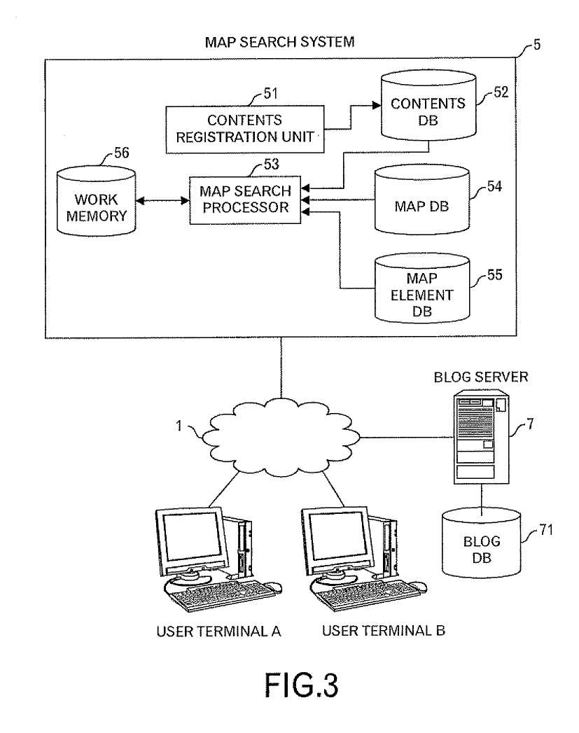

FIG. 3 shows an outline of a system according to a first embodiment of this invention. A map search system 5 that carries out a main processing in this embodiment, one or plural Blog servers 7 that manage a Blog DB 71 storing Blog data, and plural user terminals (user terminals A and B in FIG. 3) are connected to a network 1 such as the Internet. The user terminal is a personal computer or a cellular phone, for example, to which a Web browser is installed and which can access the Blog server 7 and the map search system 5 to browse the Blog data and map data. In addition, the user terminal can register data to the Blog server 7 and the map search system 5.

In addition, the map search system 5 has a contents DB 52 storing data concerning the Blog associated with the map; a contents registration unit 51 that carries out a processing to register data into the contents DB 52; a map DB 54 storing data concerning the map; a map element DB 55 storing data concerning the map elements to be displayed on the map; a work memory 56; and a map search processor 53 to carry out a map search processing and a display data generation processing by using the contents DB 52, the map DB 54, the map element DB 55 and the work memory 56.

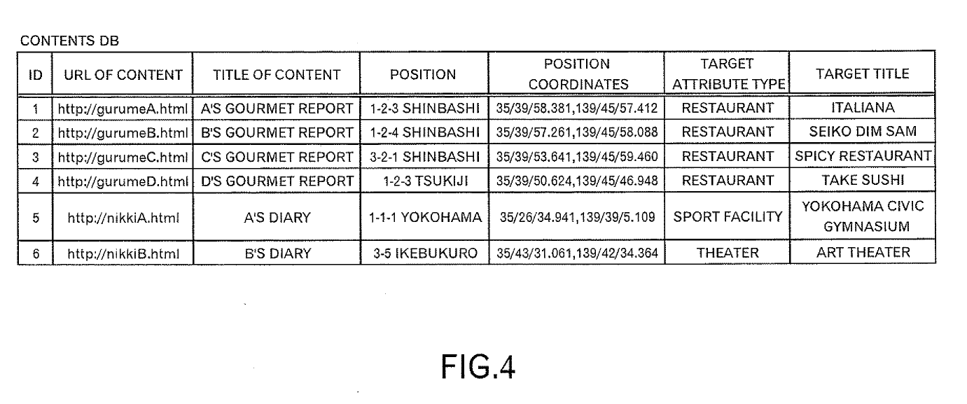

FIG. 4 shows an example of data stored in the contents DB 52. In an example of FIG. 4, an ID of a content (here, Blog), a Uniform Resource Locator (URL) of the content, a title of the content, a position, position coordinates, a target attribute type, and a target name are registered into the table. Such data is registered by a contents creator or the like. The URL of the content is a URL of the Blog, for example.

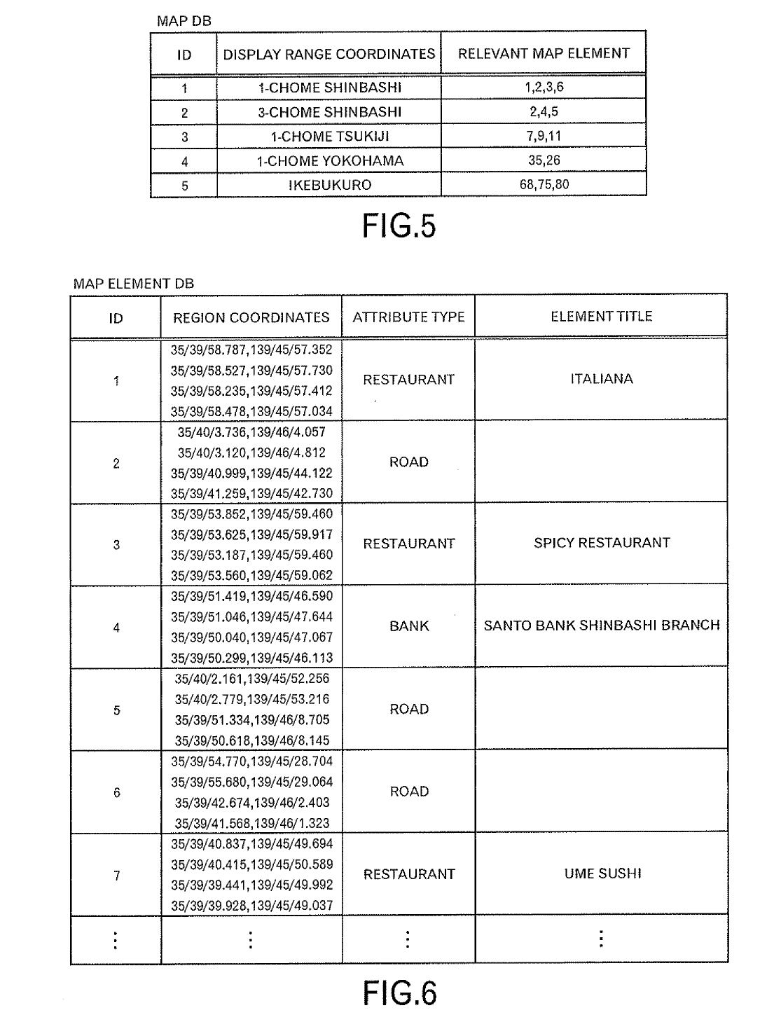

In addition, FIG. 5 shows an example of data stored in the map DB 54. In an example of FIG. 5, a map ID, a display range coordinates (here, covering addresses), and an relevant map element ID of the map element in the display range are registered in the table. Incidentally, in the map DB 54, map data itself corresponding to the map ID is also registered.

Furthermore, FIG. 6 shows an example of data stored in the map element DB 55. In an example of FIG. 6, a map element ID, region coordinates (e.g. latitudes/longitudes of four points of a square), an attribute type, and an element title are registered in the table. The data in the map element DB 55 is properly updated by an administrator of the map search system 5. In this embodiment, it is assumed that the map data is updated comparatively promptly according to the current state.

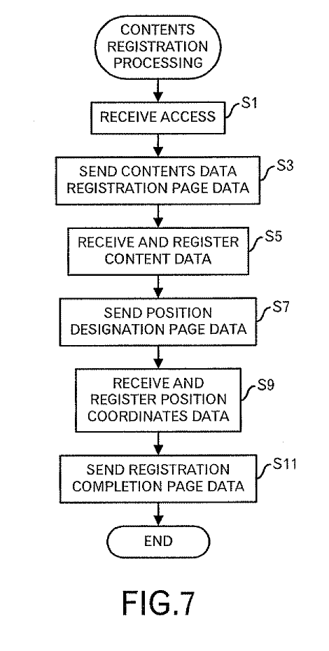

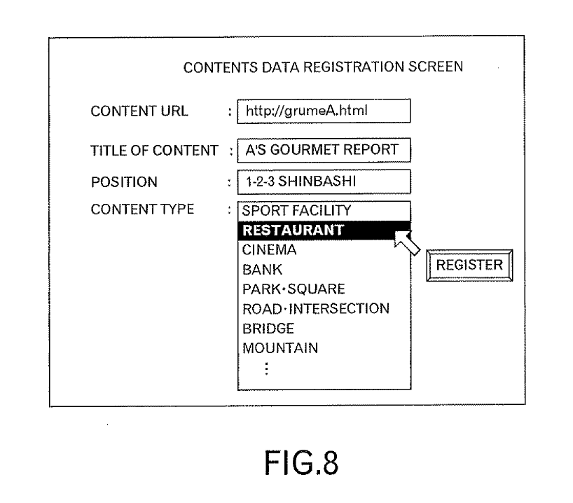

Next, a processing by the map search system 5 will be explained by using FIGS. 7 to 13. First, a contents data registration processing will be explained by using FIGS. 7 and 8.

For example, a user who registers the Blog into the contents DB 52 operates the user terminal (e.g. the user terminal B) to causes the user terminal to access a contents data registration page of the map search system 5. The contents registration unit 51 of the map search system 5 receives the access from the user terminal B (step S19), and transmits the contents data registration page data to the user terminal B (step S3). The user terminal B receives the contents data registration page data from the map search system 5, and displays the contents data registration page on a display device.

For example, a screen as shown in FIG. 8 is displayed on the display device. In the contents data registration screen of FIG. 8, an input column of a content URL, an input column of a content title, an input column of a position (i.e. address), a combo box to select a content type, and a register button are provided. The user operates the user terminal B to input data into the input columns, and selects data in the combo box. Then, when clicking the register button, the user terminal B transmits contents data including the input data and the selected data to the map search system 5.

The contents registration unit 51 of the map search system 5 receives data of the content from the user terminal B, and registers the data of the content into the contents DB 52 (FIG. 4) (step S5). For example, the contents registration unit 51 serially issues a content ID, and adds one new record into the contents DB 52. Incidentally, at this stage, the position coordinates (latitude/longitude) is not registered.

Then, the contents registration unit 51 of the map search system 5 transmits a position designation page data to the user terminal B (step S7). For example, according to the position data (here, address data) included in the data of the content, the contents registration unit 51 extracts the pertinent map data from the map DB 54, generates the position designation page data to designate specific position coordinates, and transmits the page data to the user terminal B.

The user terminal B receives the position designation page data from the map search system 5, and displays the position designation page on the display device. The user operates the user terminal B to designate the position of the store or the like relating to the content, and transmits the position coordinate data to the map search system 5.

The contents registration unit 51 of the map search system 5 receives the position coordinate data from the user terminal B, and registers the position coordinate data into the column of the position coordinates in the contents DB 52 (step S9). Then, the contents registration unit 51 transmits registration completion page data to the user terminal B (step S11).

The user terminal B receives the registration completion page data from the map search system 5, and displays the registration completion page on the display device.

By repeating such a processing, data is stored into the contents DB 52.

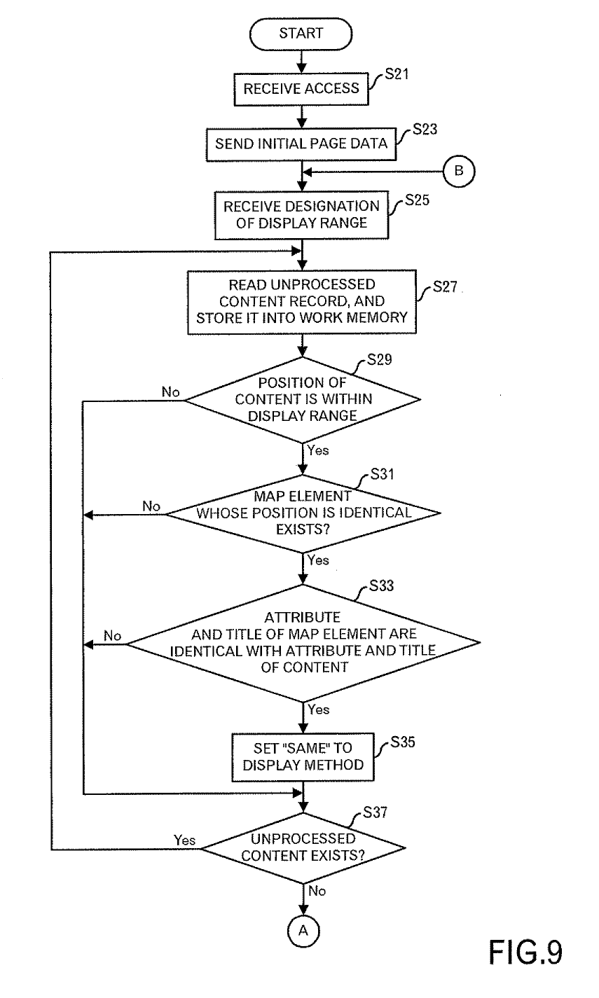

Next, a processing when browsing the map data will be explained by using FIGS. 9 to 13. For example, the user operates the user terminal A to cause the user terminal A to access an initial page of the map search system 5. The map search processor 53 of the map search system 5 receives the access from the user terminal A (step S21), and transmits the initial page data to the user terminal A (step S23). For example, the map search processor 53 reads out data of a default designated map from the map DB 54, generates the initial page data by using the default designated map, and transmits the initial page data. The user terminal A receives the initial page data from the map search system 5, and displays the initial page on the display device.

Incidentally, although a specific processing is omitted in the processing flow of FIG. 9 because it is well-known, the user operates the user terminal A to cause it to carry out a processing to scroll the map down or up to the display range desired to be displayed. Then, the user terminal A accepts an instruction of the user, and transmits the instruction data for the display range instructed to be displayed to the map search system 5.

The map search processor 53 of the map search system 5 receives the instruction data for the display range from the user terminal A (step S25), and stores the data into a storage device such as a main memory. In addition, at this stage, the work memory 56 is initialized.

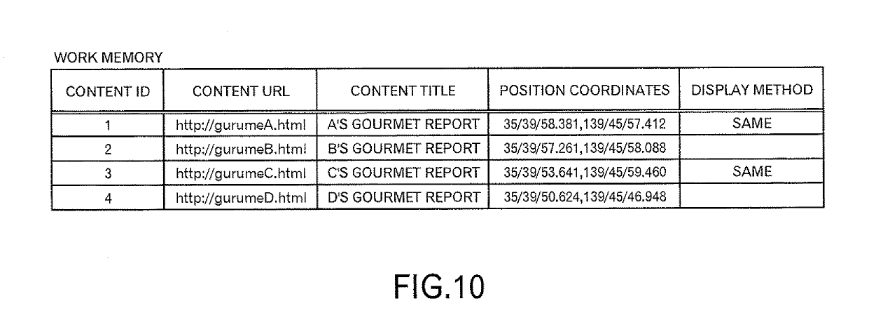

Then, the map search processor 53 reads out an unprocessed content record from the contents DB 52, and stores the record into the work memory 56 (step S27). As shown in FIG. 10, the URL of the content, the title of the content and the position coordinates are read out from the contents DB, and stored into the work memory 56. However, the display method has not been set at this stage, yet. Then, the map search processor 53 judges whether or not the position of the content is within the display range (step S29). This is judged from the position coordinates of the content. When the position of the content is out of the display region, the processing shifts to step S37. On the other hand, when the position of the content is within the display range, the map search processor 53 judges whether or not the map element whose position is identical with that of the content or whose position includes that of the content exists (step S31). Firstly, by identifying relevant map elements of the map pertinent to the display range by using the map DB 54 and searching the map element DB 55 by the IDs of the identified relevant map elements, the map search processor 53 identifies region coordinates of each map element. Then, the map search processor 53 judges whether or not the map element whose region coordinates are identical with the position coordinates of the content or whose region coordinates includes the position coordinates of the content exists.

When there is no map element whose position is identical with that of the content or whose position includes that of the content, the processing shifts to the step S37. On the other hand, when there is a map element whose position is identical with that of the content or whose position includes that of the content, the map search processor 53 judges whether or not the attribute and title of the map element conforms with the attribute and title of the content (step S33). The map search processor 53 judges, by comparing, whether or not the target attribute type of the content is identical with the attribute type of the map element, and judges, by comparing, whether or not the target title of the content is identical with the element title of the map element. When either one or both of them are not identical, the processing shifts to the step S37. On the other hand, when both of them are identical, the map search processor 53 sets “same” to the display method of the content, and stores this setting into the work memory 56 (step S35).

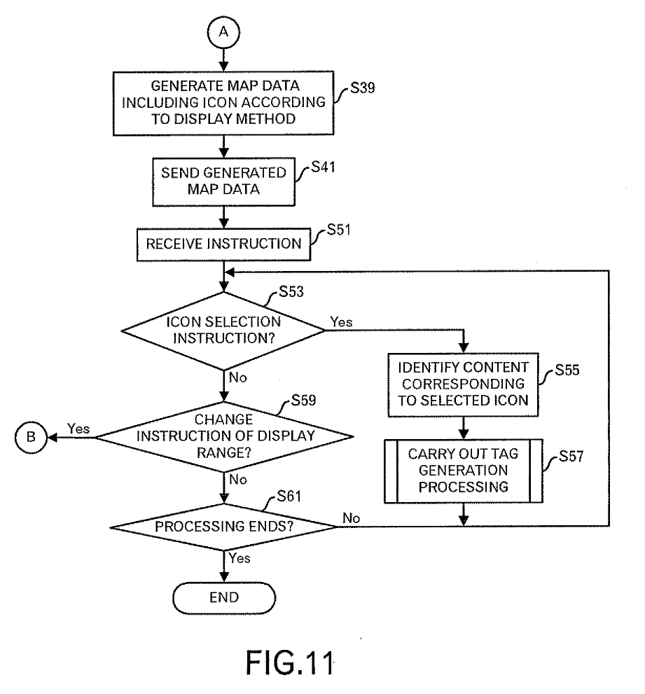

Then, the map search processor 53 judges whether or not an unprocessed content exists (step S37). When there is an unprocessed content, the processing shifts to the step S27. When all of the contents have been processed, the processing shifts to a processing of FIG. 11 through a terminal A.

Shifting to the explanation of FIG. 11, the map search processor 53 reads out data of the map pertinent to the display range from the map DB 54, and also reads out data of the pertinent relevant map element from the map element DB 55, and further reads out records within the display range from the work memory 56. Then, the map search processor 53 disposes a normal icon (also called “pin”) of the content for which “same” is set as the display method, on the map, and disposes an icon different from the normal one, for the content whose display method is not “same”. When the content overlaps with the map element, the content is preferential. Thus, the map search processor 53 generates map data including icons according to the display method (step S39), and transmits the generated map data to the user terminal A (step S41).

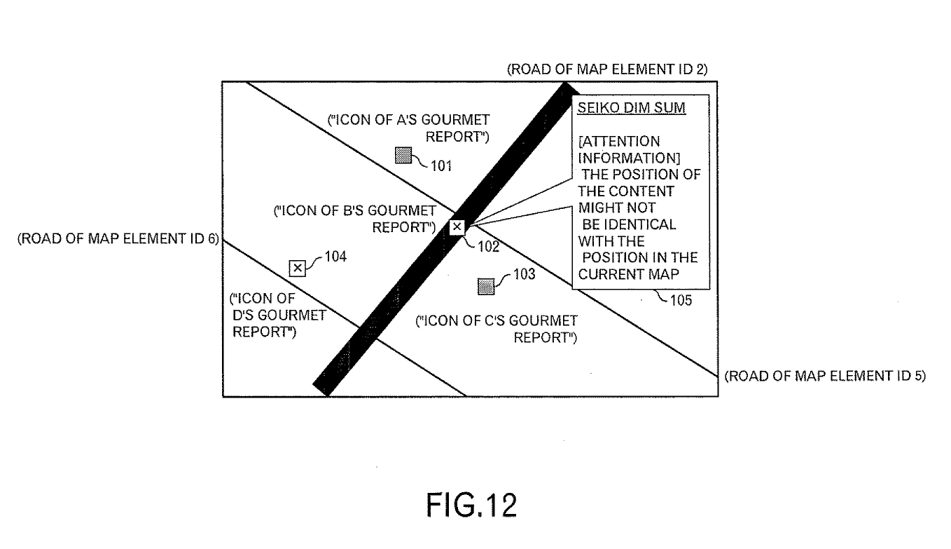

The user terminal A receives the map data from the map search system 5, and displays the map data on the display device. For example, a screen as shown in FIG. 12 is displayed. In an example of FIG. 12, a road whose map element ID is “2”, and roads whose map element IDs are “5” and “6” are disposed, and further icons 101 to 104 relating to the contents are also disposed. The icon 101 is an icon of “A's gourmet report”, the attribute type of the map element is identical with the target attribute type of the content, and the element title of the map element is identical with the target title of the content. Similarly, the icon 103 is an icon of “C's gourmet report”, the attribute type of the map element is identical with the target attribute type of the content, and the element title of the map element is identical with the target title of the content. On the other hand, the icon 102 is an icon of “B's gourmet report”, the attribute type of the map element is not identical with the target attribute type of the content, and the element title of the map element is not identical with the target title of the content. The content is old, and it can be understood that the restaurant changes to the road. Furthermore, the icon 104 is an icon of “D's gourmet report”, the attribute type of the map element is identical with the target attribute type of the content, but the element title of the map element is not identical with the target title of the content. Because the content is old, the restaurant is changed. Thus, the icon is changed for the content whose display method is not “same”. Accordingly, the user can recognize the state easily.

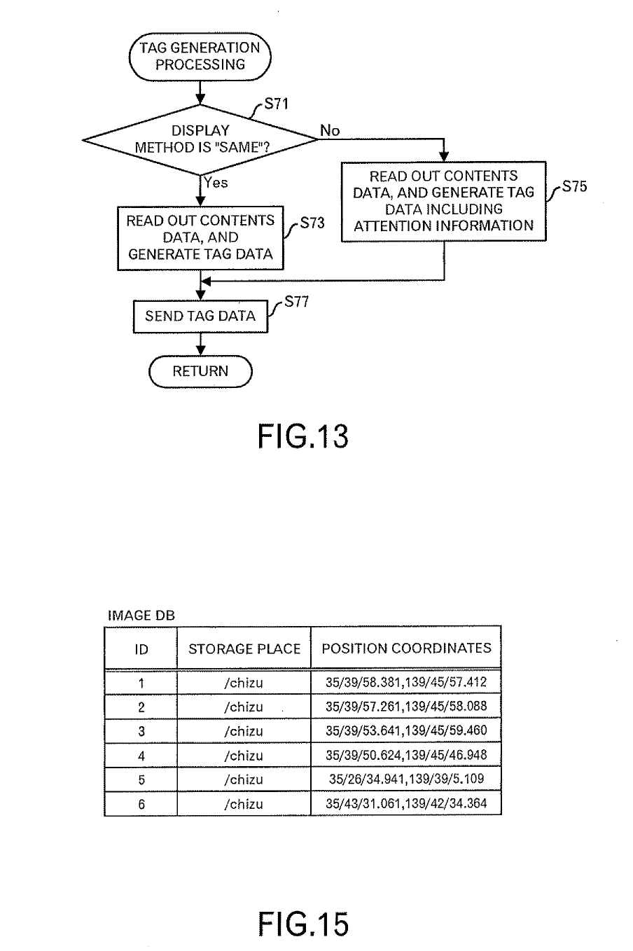

Then, the user instructs an input to the user terminal A. For example, the change of the display range is instructed, or any one of the icons is clicked. The user terminal A accepts instruction data, and transmits the instruction data to the map search system 5. The map search processor 53 of the map search system 5 receives the instruction data from the user terminal A (step S51), and judges whether or not an icon selection instruction was carried out (step S53). When the icon selection instruction was carried out, the map search processor 53 identifies the content corresponding to the selected icon from the ID of the content, which is included in the icon selection instruction (step S55), and carries out a tag generation processing (step S57). The tag generation processing will be explained by using FIG. 13.

The map search processor 53 searches the work memory 56 by the content ID, and judges whether or not the display method of the pertinent record is “same” (FIG. 13: step S71). When the display method is “same”, the map search processor 53 reads out the content data including the content title and the content URL from the work memory 56, generates tag data (step S83), and transmits the tag data to the user terminal A (step S77).

On the other hand, when the display method is not “same”, the map search processor 53 reads out the content data including the content title and the content URL from the work memory 56, generates tag data further including attention information “[attention information] the position of the content might not be identical with the position in the current map!!”, and transmits the tag data to the user terminal A (step S77).

As shown in FIG. 12, when the icon 102 is clicked, for example, the tag 105 is displayed. In the tag 105, a link of the content URL is set to “Seiko Dim Sum”, and [attention information] is included. Incidentally, when the tag 105 is generated, the Blog server 7 may be accessed by using the content URL to read other data and include other data into the tag data. For example, the registration date of the Blog and portion of the content may be included.

Returning to the explanation of FIG. 11, when the step S57 is completed, the processing returns to the step S53.

On the other hand, when the icon selection instruction was not carried out, the map search processor 53 judges whether or not a display range change instruction was carried out (step S59). When the display range change instruction was carried out, the processing shifts to the step S25 of FIG. 9 through a terminal B. On the other hand, when the display range change instruction was not carried out, the map search processor 53 judges whether or not the end of the processing was instructed (step S61). When the end of the processing was not instructed, the processing returns to the step S53. On the other hand, when the end of the processing was instructed, this processing is terminated.

By carrying out such a processing, when old content has still been registered, the attribute data of the content is not identical with the attribute data of the map element, and it becomes possible to urge the user to pay attention.

Incidentally, although an example that “same” is set as the display method was indicated, it is possible to register “different”. Furthermore, an example that the content data is registered into the work memory 56 and the processing is carried out based on the content data was indicated. However, the processing may be carried out based on the map element within the display range.

### Embodiment 2

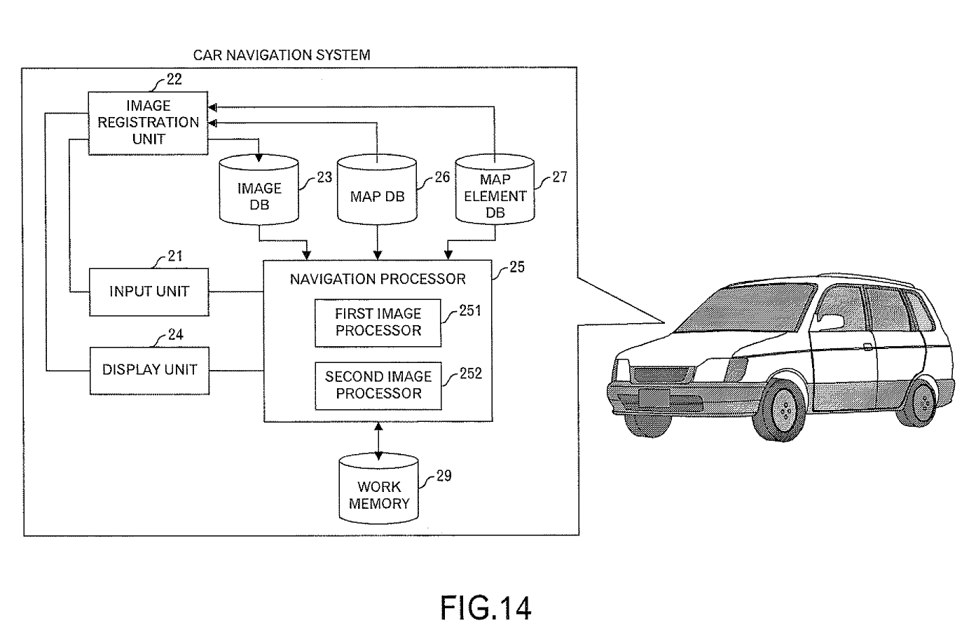

FIG. 14 shows a functional block diagram of a car navigation system according to a second embodiment of this invention. The car navigation system equipped in the car has an operation part such as buttons; an input unit 21 including a drive of CD or DVD, a reader unit of a memory card or the like; a display unit 24, which is a touch-panel type display apparatus, for example; an image DB 23 storing photos (i.e. image data) registered by the user; a map DB 26 storing map data; a map element DB 27 storing data concerning map elements displayed on the map; an image registration unit 22 that registers the image data into the image DB 23 by using data stored in the map DB 26 and map element DB 27 and cooperating with the input unit 21 and the display unit 24; a work memory 29; and a navigation processor 25 that carries out a processing described later by using the image DB 23, the map DB 26, the map element DB 27 and the work memory 29 and cooperating with the input unit 21 and the display unit 24.

The navigation processor 25 has a first image processor 251 that carries out a processing while the car is running, and a second image processor 252 that carries out a processing at a destination setting, and can obtain data of its own position from a GPS system, which is not shown.

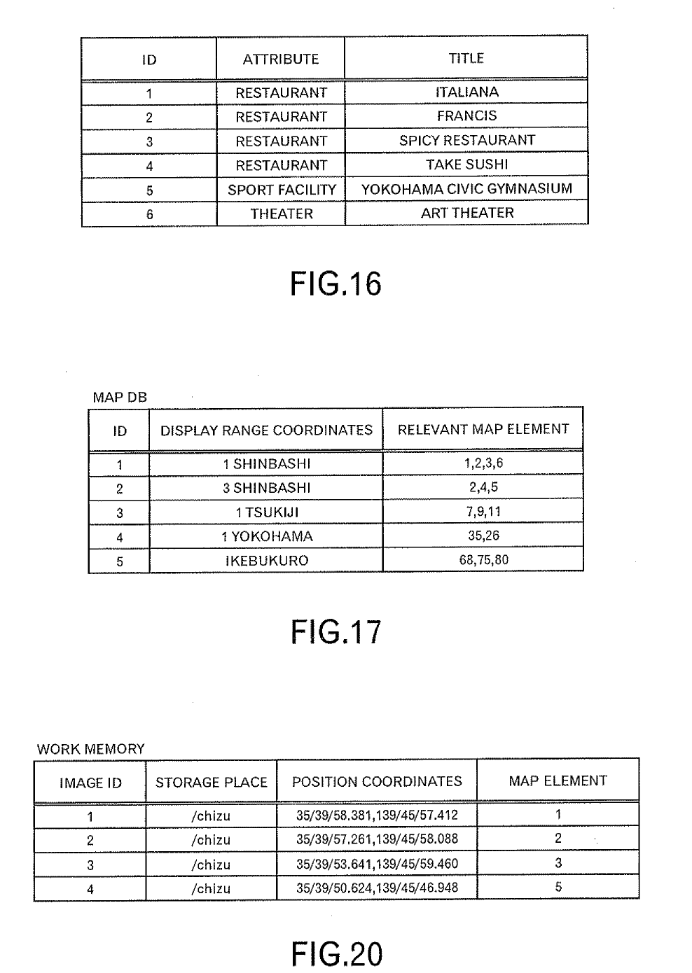

FIG. 15 shows an example of data stored in the image DB 23. In an example of FIG. 15, an image ID, a storage place (directory) in the image DB 23, and position coordinates are registered in the table. For example, the user inputs an image photographed by a digital camera or the like and stored in the DVD or the like into the image registration unit 22 through the DVD drive of the input unit 21, and designates the position coordinates to be registered in the map displayed on the display unit 24 by the image registration unit 22. The image registration unit 22 accepts the image data and the position coordinates inputted by the user, issues an image ID in serial, identifies a storage place directory, and registers those data into the image DB 23. Rightly, the image data itself is also stored in the designated storage place directory. Incidentally, in this embodiment, the Exif format is adopted as the format of the image data, and as shown in FIG. 16, the image data itself includes attributes and title. Namely, the navigation processor 25 can obtain the attribute and title in addition to the data shown in FIG. 15 by reading the image data.

When the car navigation system has a communication function, the image photographed by a cellular phone with a camera, for example, may be transmitted to the car navigation system as it is, and the image registration unit 22, which received image data, may stores the image data into the image DB 23. At this time, when the cellular phone has a Global Positioning System (GPS) function, the position coordinates may be registered into the image data itself.

In addition, FIG. 17 shows an example of data stored in the map DB 26. In an example of FIG. 17, a map ID, display range coordinates (here, covering addresses), and relevant map element IDs of map elements in the display range are registered in the table. Incidentally, the map data corresponding to the map ID is also registered in the map DB 26.

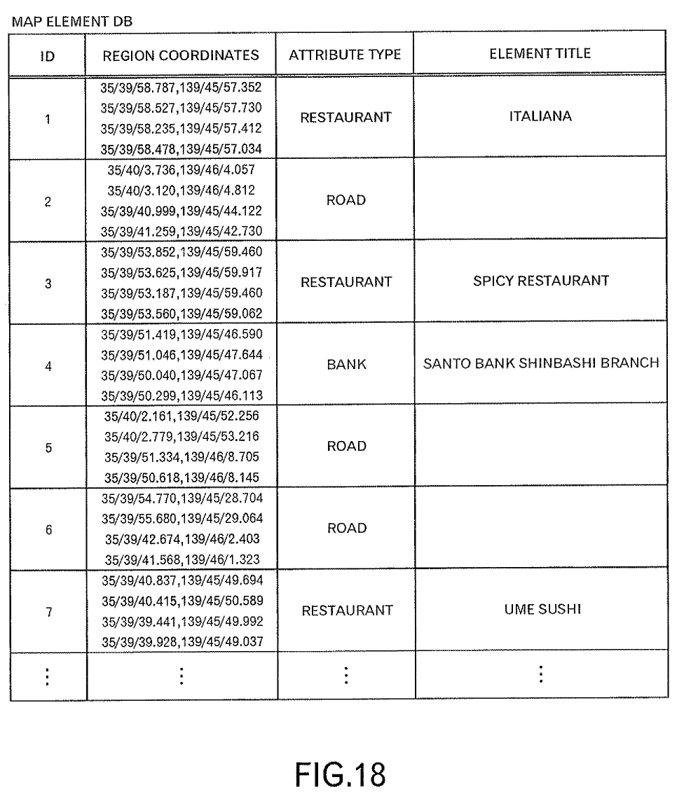

Furthermore, FIG. 18 shows an example of data stored in the map element DB 27. In an example of FIG. 18, a map element ID, region coordinates (e.g. latitudes/longitudes of four points of a square), an attribute type and an element title are registered in the table. When the car navigation system has the communication function, the data in the map element DB 27 may be updated by a service from a manufacturer of the car navigation system or the data may be updated by an update DVD, for example. However, in this embodiment, it is assumed that the update of the map data requires relatively long time.

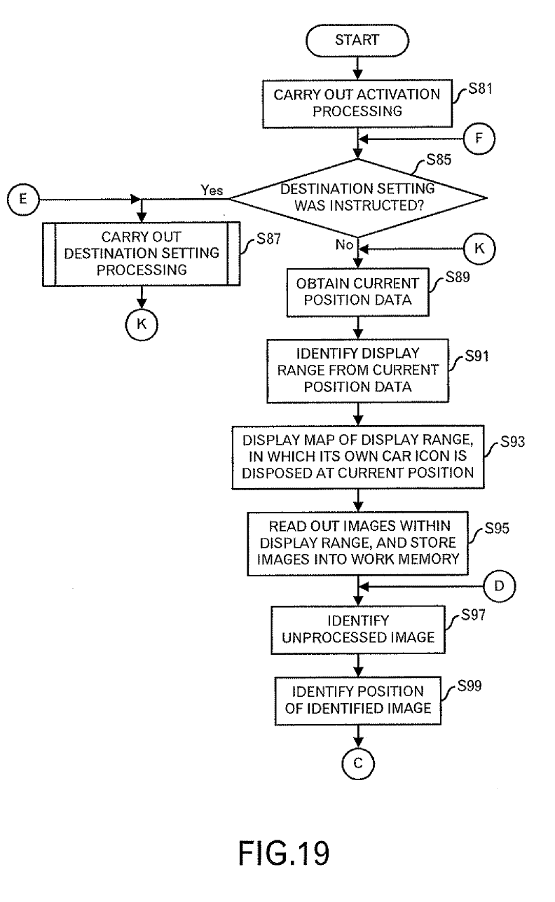

Next, a processing of the car navigation system will be explained by using FIGS. 19 to 25. For example, in response to the start of the engine of the car, an activation processing of the car navigation system is carried out (step S81). Specifically, a predetermined initialization processing is carried out. Then, the navigation processor 25 judges whether or not a destination setting was instructed through the input unit 21 or the display unit 24 (step S85). When the destination setting was instructed, the second image processor 252 carries out a destination setting processing (step S87). Incidentally, this processing will be explained in detail later. In addition, when this processing is completed, the processing shifts to step S89 through a terminal K.

On the other hand, when the destination setting was not instructed, the first image processor 251 carries out a following in-running processing. Specifically, the first image processor 251 obtains current position data from the GPS system, and stores the current position data into a storage device such as a main memory (step S89). Then, the first image processor 251 identifies a display range from the current position data by referring to the map DB 26 (step S91), reads out the map data of the display range from the map DB 26 and generates map data of the display range, in which its own car icon is disposed at the current position, and displays the map on the display unit 24 (step S93).

Then, the first image processor 251 extracts images whose position coordinates are within the display range from the image DB 23, and stores the image data into the work memory 29 (step S95). For example, data as shown in FIG. 20 is stored. In an example of FIG. 20, an image ID, a storage place (directory), and position coordinates are stored for each of image IDs 1 to 4. Incidentally, the map element ID is not stored at this stage.

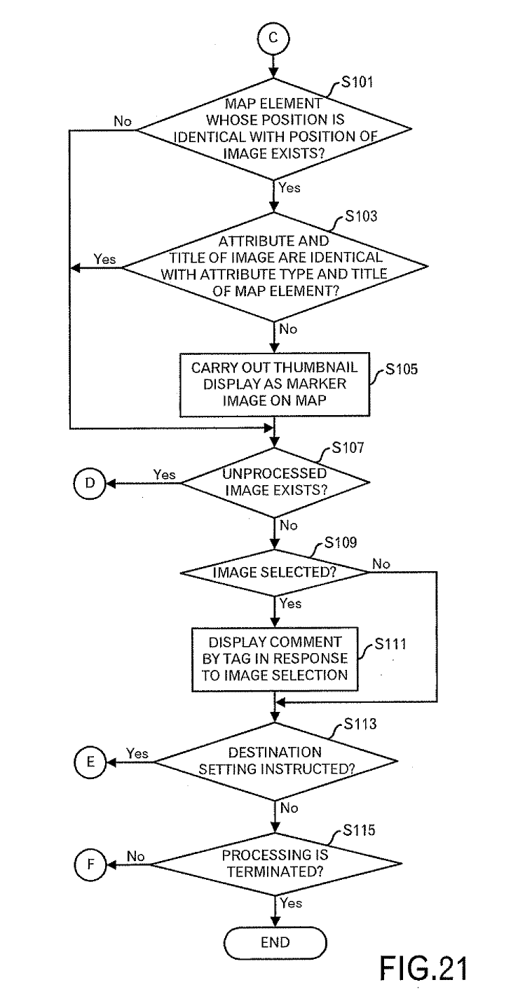

Next, the first image processor 251 identifies an unprocessed image in the work memory 29 (step S97). Then, the first image processor 251 identifies position coordinates of the identified image (step S99). The processing shifts to a processing of FIG. 21 through a terminal C.

Shifting to the explanation of the processing of FIG. 21, the first image processor 251 searches the map element DB 27 by the position coordinates of the image, and judges whether or not the map element whose region coordinates are identical with the position coordinates of the image or include the position coordinates of the image exists (step S101). When there is no map element whose region coordinates are identical with the position coordinates of the image or include the position coordinate of the image, the processing shifts to step S107. On the other hand, when there is a map element whose region coordinates are identical with the position coordinates of the image or include the position coordinates of the image, the first image processor 251 registers the map element ID of the pertinent map element into the work memory 29, reads out data of the image from the image DB 23, and judges whether or not the attribute and title included in the image data are identical with the attribute type and the element title of the map element, which are registered in the map element DB 27 (step S103). The first image processor 251 judges whether or not the attribute included in the image data is identical with the attribute type of the map element, and further judges whether or not the title included in the image data is identical with the element title of the map element. When both of them are identical, this image is a snapshot and is unnecessary information for the running car. Therefore, the processing shifts to the step S107.

On the other hand, when either of the attribute and the title or both of them are different, the first image processor 251 carries out a thumbnail display of the image on the map in the current display as the image for the marker (called a marker image later) (step S105). Thus, when either of the attribute and the title or both of them are different, because the update of the map DB 26 and the map element DB 27 is not carried out, the marker image is presented for the user in the moving in order to indicate the error of the map and urge the user to pay attention.

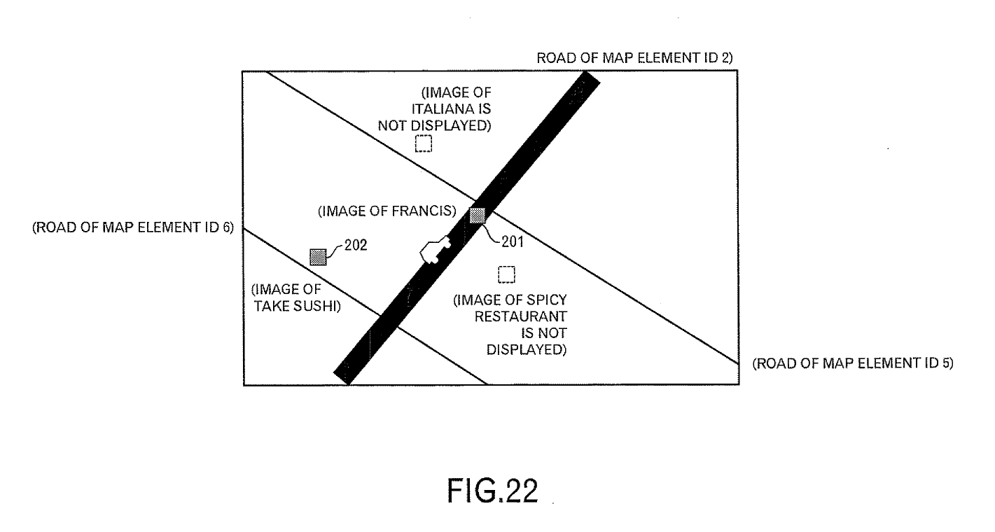

For example, a screen as shown in FIG. 22 is displayed on the display device. The image IDs of the images registered in the work memory 29 are 1 to 4, and those images correspond to “Italiana”, “Francis”, “Spicy restaurant” and “Take Sushi”. In this example of FIG. 22, the thumbnail images of “Francis” and “Take Sushi” whose attribute or title is not identical with that of the map element are displayed. The images of “Italiana” and “Spicy restaurant” are not displayed.

Then, the first image processor 251 judges whether or not an unprocessed image exists (step S107). When an unprocessed image exists, the processing returns to the step S97 in FIG. 19 through a terminal D. On the other hand, when all images in the work memory 29 have been processed, the first image processor 251 judges whether or not the user carried out image selection through the display unit 24 (step S109). When the image selection was not carried out, the processing shifts to the step S113. On the other hand, when the image selection was carried out, the navigation processor 25 accepts an input of the image selection through the display unit 24, and displays a comment (title, comment and the like, which are included in the image data) by the tag in response to the image selection (step S111).

In addition, the navigation processor 25 judges whether or not the destination setting was instructed by the user (step S113), and when the destination setting was instructed, the processing shifts to the step S87 of FIG. 19 through the terminal E. On the other hand, when the destination setting was not instructed, the navigation processor 25 judges whether or not the processing should be terminated, that is, the end of the processing of the car navigation system was instructed (step S115). When the processing is not terminated, the processing shifts to the step S85 of FIG. 19 through a terminal F. On the other hand, when the processing should be terminated, the processing is terminated.

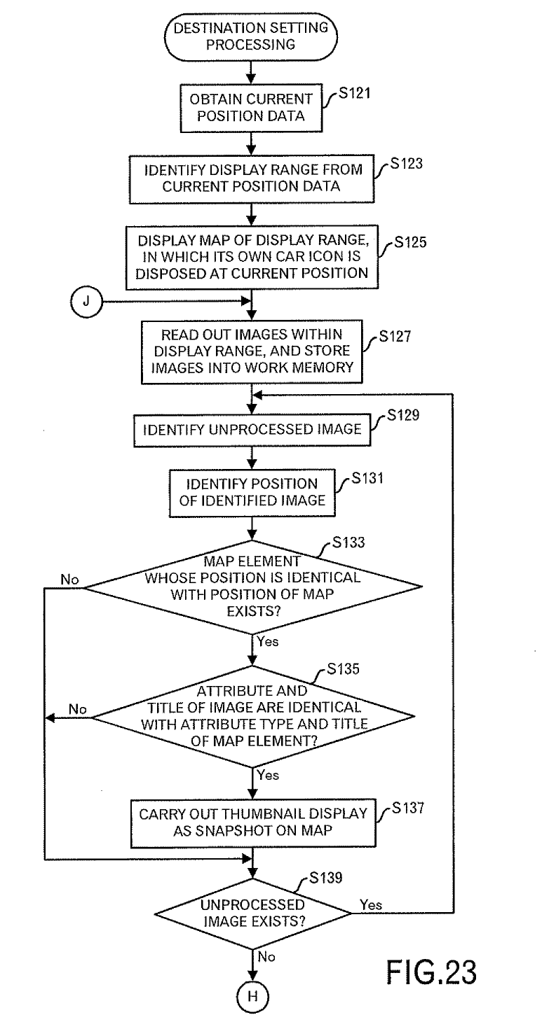

Next, the destination setting processing carried out at the step S87 of FIG. 19 will be explained by using FIGS. 23 to 25.

Namely, when the destination setting was instructed, the second image processor 252 carries out a following processing. Specifically, the second image processor 252 obtains the current position data from the GPS system, and stores the current position data into the storage device such as the main memory (step S121). Then, the second image processor 252 identifies the display range from the current position data by referring to the map DB 26 (step S123), reads out the map data of the display range from the map DB 26 and generates the map data of the display range, in which its own car icon is disposed at the current position, and displays the map on the display unit 24 (step S125).

Then, the second image processor 252 extracts the image whose position coordinates are within the display range from the image DB 23, and stores the image data into the work memory 28 (step S127). For example, data as shown in FIG. 20 is stored. Incidentally, the map element ID is not stored at this stage.

Next, the second image processor 252 identifies an unprocessed image in the work memory 29 (step S129). Then, the second image processor 252 identifies the position coordinates of the identified image (step S131). Furthermore, the second image processor 252 searches the map element DB 27 by the position coordinates of the image, and judges whether or not the map element whose region coordinates are identical with the position coordinates of the image or include the position coordinates of the image exists (step S133). When there is no map element whose region coordinates are identical with the position coordinates of the image or include the position coordinates of the image, the processing shifts to the step S139. On the other hand, when there is a map element whose region coordinates are identical with the position coordinates of the image or include the position coordinates of the images, the second image processor 252 registers the map element ID into the work memory 29, reads out the image data from the image DB 23, and judges whether or not the attribute and title included in the image data are identical with the attribute type and element title of the map element, which are registered in the map element DB 27 (step S135). The second image processor 252 judges whether or not the attribute included in the image data is identical with the attribute type of the map element, and further judges whether or not the title included in the image data is identical with the element title of the map element. When either of the attribute and the title or both of them are not identical, the image is the marker image, and as the unnecessary information for the destination setting processing, the processing shifts to the step S139.

On the other hand, when both of the attribute and the title are identical, the second image processor 252 carries out a thumbnail display of the image on the currently displayed map as a snapshot (step S137). Thus, when both of the attribute and the title are identical, because the image is an image to help the setting of the destination such as a place where the user went in the past or a memorial place, the existence is displayed for the user in the destination setting.

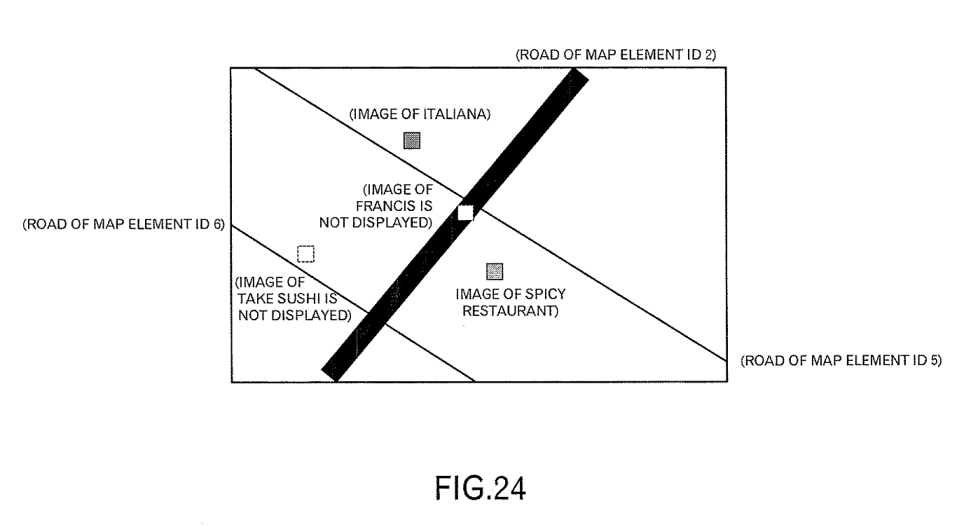

For example, a screen as shown in FIG. 24 is displayed on the display device. The image IDs of the images registered in the work memory 29 are 1 to 4, and the images correspond to “Italiana”, “Francis”, “Spicy restaurant” and “Take Sushi”. However, in the example of FIG. 24, the thumbnail images of “Italiana” and “Spicy restaurant” whose attribute and title are identical with those of the map element are displayed. The images of “Francis” and “Take Sushi” are not displayed.

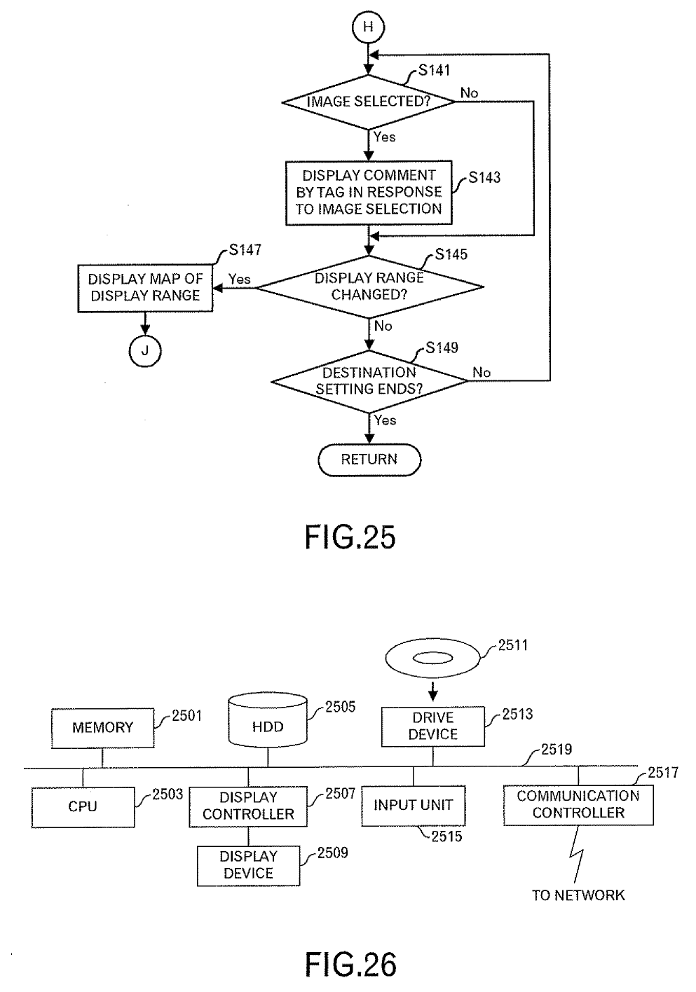

Then, the second image processor 252 judges whether or not there is an unprocessed image (step S139). When there is an unprocessed image, the processing shifts to the step S129. On the other hand, when all images in the work memory 29 have been completed, the processing shifts to the processing of FIG. 25 through a terminal H.

Shifting to the explanation of the processing of FIG. 25, the navigation processor 25 judges whether or not the user carried out image selection through the display unit 24 (step S141). When the image selection was not carried out, the processing shifts to step S145. On the other hand, when the image selection was carried out, the navigation processor 25 accepts an input of the image selection through the display unit 24, and displays a comment (title, comment and the like, which are included in the image data) by the tag in response to the image selection (step S143).

Then, the navigation processor 25 judges whether or not the change of the display range was instructed by the user through the display unit 24 (step S145). When the change of the display range was instructed, the second image processor 252 reads out the map data of the changed display range from the map DB 26, further reads out data of the relevant map elements from the map element DB 27, constructs the map of the changed display range, and cause the display unit 24 to display the map of the changed display range (step S147). Then, the processing shifts to the step S127 of FIG. 23 through a terminal J.

On the other hand, when the change of the display range was not instructed, the navigation processor 25 judges whether or not the destination setting is completed (step S149), and when the destination setting is not completed, the processing returns to the step S141. On the other hand, when the destination setting is completed, the processing returns to the original processing.

By carrying out such a processing, while referring to the image, which is a guidepost of the destination setting, the destination setting can be carried out.

Incidentally, if the processing as shown in this embodiment is carried out, when data in the map element DB 27 is updated to the newest data, the attribute and title of the content whose attribute or title was not identical become identical. Then, the image displayed at the step S105 of FIG. 21 is not displayed, and is displayed at the step S137 of FIG. 23. That is, without carrying out special maintenance for the images registered in the image DB 23, the display modes can be changed.

Incidentally, although an example that the thumbnail display is carried out was indicated, the icon display may be carried out instead of the thumbnail display.

In addition, although an example that the image is registered in the image DB 23 was indicated, a memo may be simply registered and an icon corresponding to the memo may be displayed in the aforementioned processing. A marker memo icon may be registered instead of the marker image, and the marker memo icon may be displayed at a timing when the marker image is displayed. In addition, a comment such as an impression may be registered instead of the snapshot, and a comment icon may be displayed at a timing when the snapshot is displayed.

Furthermore, the image data in the Exif format was presumed. However, like the first embodiment, a table may be provided in the contents DB.

As described above, although the embodiments were explained, this invention is not limited to those. The aforementioned functional block diagrams do not always represent an actual program configuration and component configuration.

In addition, as long as the processing results are not changed, the processing flow can be changed, the direction of the flags can be changed, additional data can be held, and the processing order of the steps can be exchanged.

Incidentally, the map search system and the car navigation system are computer devices as shown in FIG. 26. That is, a memory 2501 (storage device), a CPU 2503 (processor), a hard disk drive (HDD) 2505, a display controller 2507 connected to a display device 2509, a drive device 2513 for a removal disk 2511, an input device 2515, and a communication controller 2517 for connection with a network are connected through a bus 2519 as shown in FIG. 26. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in detail are realized.

The car navigation system may not have HDD 2505. However, another storage device instead of the HDD 2505 is used. In addition, the car navigation system may have a reader device of a flash-memory type storage medium. Furthermore, the car navigation system may not have the communication controller 2517.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A map data processing method, comprising:
identifying a display range of a map;
identifying a content and a map element, which are associated with a position within the identified display range of said map and whose positions are presumed to be identical, by using a contents data storage storing position data for each said content and a map element data storage storing position data and attribute data for each said map element;
comparing said attribute data of the identified content with said attribute data of the identified map element stored in said map element data storage; and
determining a display mode for said identified content based on a comparison result, and outputting said map within said identified display range, wherein said map includes display data according to the determined display mode.

2. The map data processing method as set forth in claim 1, wherein said identifying said content and said map element comprises:
identifying a content associated with a position within said identified display range of said map; and
extracting an map element at a position, which is presumed to be identical with a position of the identified content, from said map element data storage.

3. The map data processing method as set forth in claim 1, wherein said identifying said content and said map element comprises:
identifying a map element associated with a position within said identified display range of said map; and
extracting a content whose position is presumed to be identical with a position of the identified map element, from said content data storage.

4. The map data processing method as set forth in claim 1, wherein said contents data storage stores said content, and said content includes said attribute data.

5. The map data processing method as set forth in claim 1, wherein said contents data storage stores said attribute data for each said content.

6. The map data processing method as set forth in claim 1, wherein said attribute data is data concerning a content type of said content.

7. The map data processing method as set forth in claim 1, wherein, when said comparison result represents inconsistency, said display mode of said content is a mode to emphasize said inconsistency.

8. The map data processing method as set forth in claim 1, wherein, in a destination setting mode in a car navigation system, when said comparison result represents inconsistency, said display mode of said content is a mode that said content is not displayed, and
when said comparison result represent consistency, said display mode of said content is a mode that said content or display data corresponding to said content is displayed.

9. The map data processing method as set forth in claim 1, wherein, in a running mode in a car navigation system, when said comparison result represents inconsistency, said display mode of said content is a mode that said content or display data corresponding to said content is displayed, and
when said comparison result represents consistency, said display mode of said content is a mode that said content is not displayed.

10. The map data processing method as set forth in claim 1, further comprising:
in response to receiving a selection instruction of display data, outputting data concerning said content corresponding to the selected display data and data to explain inconsistency of said comparison result.

11. A map data processing program embodied on a computer-readable storage medium, said program comprising:
identifying a display range of a map;
identifying a content and a map element, which are associated with a position within the identified display range of said map and whose positions are presumed to be identical, by using a contents data storage storing position data for each said content and a map element data storage storing position data and attribute data for each said map element;
comparing said attribute data of the identified content with said attribute data of the identified map element stored in said map element data storage; and
determining a display mode for said identified content based on a comparison result, and outputting said map within said identified display range, wherein said map includes display data according to the determined display mode.

12. A map data processing apparatus, comprising:
a unit that identifies a display range of a map;
a unit that identifies a content and a map element, which are associated with a position within the identified display range of said map and whose positions are presumed to be identical, by using a contents data storage storing position data for each said content and a map element data storage storing position data and attribute data for each said map element;
a unit that compares said attribute data of the identified content with said attribute data of the identified map element stored in said map element data storage; and
a unit that determines a display mode for said identified content based on a comparison result, and outputs said map within said identified display range, wherein said map includes display data according to the determined display mode.
